(19) United States
(12) Patent Application Publication
(10) Pub. No.: US 2017/0374025 A1
(43) Pub. Date: Dec. 28, 2017

(54) INTERNET PROTOCOL SECURITY (IPSEC) INTERFACE CONFIGURATION AND MANAGEMENT

(71) Applicant: Fortinet, Inc., Sunnyvale, CA (US)

(72) Inventor: Yixin Pan, Burnaby (CA)

(73) Assignee: Fortinet, Inc., Sunnyvale, CA (US)

(21) Appl. No.: 15/195,678

(22) Filed: Jun. 28, 2016

(51) Int. Cl. H04L 29/06

(52) U.S. Cl. CPC H04L 63/0209; H04L 63/205; H04L 63/029; H04L 63/164

(57) ABSTRACT

Systems and methods for bundling multiple IPsec dialup tunnels into a single IPsec interface are provided. According to one embodiment, an Internet Protocol security (IPsec) interface is configured between a first network device and a second network device, by the first network device and the IPsec interface is associated with a static Internet Protocol (IP) address. A first tunnel associated with the IPsec interface is created for a first client device based on a first client request received at the first network device and the first tunnel is assigned the static IP address. A second tunnel associated with the IPsec interface is created for a second client device based on a second client request received at the first network device and the second tunnel is assigned the static IP address.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2016, Fortinet, Inc.

### BACKGROUND

### Field

Embodiments of the present invention generally relate to secure network packet processing. In particular, embodiments of the present invention relate to a system and method for efficient, advanced configuration and management of an Internet Protocol Security (IPsec) interface so as to avoid establishing and tearing down of IPsec interfaces responsive to new and/or terminated IPsec connections.

### Description of the Related Art

Internet Protocol Security (IPsec) is a protocol configured to provide security services for secure Internet Protocol (IP) communication between network devices by authenticating and encrypting each IP packet of a communication session. IPsec enables encryption of sensitive data, authentication, and protection against replay and data confidentiality. IPsec includes protocols for establishing mutual authentication between two computing/network devices at the beginning of a communication session, and negotiation of cryptographic keys to be used during the session. IPsec can be used in protecting data flows between a pair of hosts (host-to-host), between a pair of security gateways (network-to-network), or between a security gateway and a host (network-to-host). IPsec supports network-level peer authentication, data origin authentication, data integrity, data confidentiality (encryption), and replay protection.

Internet Key Exchange (IKE) and Internet Security Agreement/Key Management Protocol (ISAKMP) are used within IPsec and carry out the key exchange negotiation process and represent key exchange architecture, respectively. A Security Association (SA) provides all the information needed for two devices to communicate securely. The SA contains a policy agreement that controls algorithms and key lengths that the two machines will use along with the actual security keys used to securely exchange information. There are two steps in this process. First, the two devices must agree on the following three things: 1) the encryption algorithm to be used (Data Encryption Standard (DES), triple DES etc.) 2) the algorithm they will use for verifying message integrity (Message Digest 5 (MD5) or Secure Hash Algorithm 1 (SHA-1) etc.), and 3) How connections will be authenticated: using a public-key certificate, a shared secret key or Kerberos. Once an agreement has been reached, the devices start another round of negotiations which cover 1) Whether the Authentication Header (AH) protocol will be used, 2) Whether the Encapsulating Security Payload (ESP) protocol will be used, 3) Which encryption algorithm will be used for ESP, and 4) Which authentication protocol will be used for AH.

A typical network device using IPsec creates a new IPsec interface or tunnel every time a secure connection request for a communication session is initiated, deletes the interface at end of the session, and flushes out the data path defined for the session. Significant computing resources of network device are used in creating and deleting such interfaces and flushing out the data path. As one may appreciate, a typical network device provides services to multiple client devices connected to it, and hence needs to create multiple interfaces for the various requests being initiated by the client device. While creating a new IPsec interface or IPsec tunnel may be easy, tearing down of the IPsec interface is computationally expensive. Each time an IPsec interface is terminated, the network device's routing table needs to be updated, which has a direct impact on dynamic routing as well. Furthermore, high volume establishment and tearing down of IPsec interfaces impacts other daemons running on the network device.

### SUMMARY

Systems and methods are described for bundling multiple IPsec dialup tunnels into a single IPsec interface. According to one embodiment, an Internet Protocol security (IPsec) interface is configured between a first network device and a second network device, by the first network device and the IPsec interface is associated with a static Internet Protocol (IP) address. A first tunnel associated with the IPsec interface is created for a first client device based on a first client request received at the first network device and the first tunnel is assigned the static IP address. A second tunnel associated with the IPsec interface is created for a second client device based on a second client request received at the first network device and the second tunnel is assigned the static IP address.

Other features of embodiments of the present invention will be apparent from the accompanying drawings and from the detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIGS. 1A and 1B illustrate exemplary network architectures known in the art for providing IPsec tunnel(s) between network devices.

FIG. 2 illustrates exemplary functional modules for IPsec interface configuration and management in accordance with an embodiment of the present invention.

FIGS. 3A and 3B illustrate exemplary network architectures using a single shared IPsec virtual interface based configuration in accordance with embodiments of the present disclosure.

FIGS. 4A to 4D illustrate exemplary representations showing tunnel creation and management over a single IPsec interface in accordance with an embodiment of the present disclosure.

FIG. 5 illustrates exemplary representations showing tunnel creation/deletion and management for multiple IPsec interfaces in accordance with an embodiment of the present disclosure.

FIG. 6A illustrates exemplary steps taken by a network device for processing a packet originated remotely (an encrypted packet) and received on a single shared IPsec interface in accordance with an embodiment of the present disclosure.

FIG. 6B illustrates exemplary steps taken by a network device for processing a packet originated locally (an unencrypted packet) to be transmitted via a single shared IPsec interface in accordance with an embodiment of the present disclosure.

FIG. 7 illustrates an exemplary flow diagram showing steps of IPsec interface creation, along with creation/management of tunnels in the created IPsec interface in accordance with an embodiment of the present disclosure.

FIG. 8 illustrates an exemplary computer system in which or with which embodiments of the present invention may be utilized.

### DETAILED DESCRIPTION

Systems and methods are described for bundling multiple IPsec dialup tunnels into a single IPsec interface. Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

If the specification states a component or feature “may”, “can”, “could”, or “might” be included or have a characteristic, that particular component or feature is not required to be included or have the characteristic.

Systems and methods are described for bundling multiple IPsec dialup tunnels into a single IPsec interface. In an aspect, a network device is provided that is capable of bundling multiple IPsec dialup tunnels into a single IPsec interface. The network device includes a non-transitory storage device having embodied therein one or more routines operable to manage a single IPsec interface to support multiple IPsec tunnels for multiple client devices, and one or more processors coupled to the non-transitory storage device and operable to execute the one or more routines that enable creation of the single IPsec interface between the network device and a second network device, and association of the single IPsec interface with a static Internet Protocol (IP) address. The network device further creates a first tunnel responsive to a request received from a first client device, and associates the first tunnel with the single IPsec interface, and creates a second tunnel responsive to a request received from a second client device, and associates the second tunnel with the single IPsec interface. In an aspect, N tunnels can be created and associated with the single IP sec interface.

In an aspect, the single IPsec interface can be configured with a static route that can be used for creating multiple tunnels, and can be created based on negotiation of security and encryption parameters between the network device and the second network device. In an aspect, a first tunnel and a second tunnel can be bound with the negotiated security and encryption parameters.

In another aspect, a first packet received at the network device from the first client device can be mapped to the first tunnel based on a destination IP address specified by the first packet. Similarly, a second packet received at the network device from the second client device can be mapped to the second tunnel based on a destination IP address specified by the second packet.

In an aspect, termination of the connection between the first client device and the network device can result in removal of the first tunnel, while maintaining the single IPsec interface as active. Similarly, termination of the connection between the second client device and the network device can result in removal of the second tunnel, while maintaining the single IPsec interface as active.

In an embodiment, a method for bundling multiple IPsec dialup tunnels into a single IPsec interface is provided, wherein the method includes steps of configuring, by a first network device, an IPsec interface between the first network device and a second network device, wherein the IPsec interface is associated with a static IP address; creating, for a first client device, a first tunnel associated with the IPsec interface based on a first client request received at the first network device, wherein the first tunnel is assigned the static IP address; and creating, for a second client device, a second tunnel associated with the IPsec interface based on second client request received at the first network device, wherein the second tunnel is assigned the static IP address.

In an aspect, the IPsec interface can be configured based on negotiation of security and encryption parameters between the first network device and the second network device, wherein the first and the second tunnels are bound with the negotiated security and encryption parameters.

In an aspect, the method further includes steps of receiving, by the first network device, a packet from a client device and identifying, by the first network device, a corresponding security association and tunnel to be used based on a destination IP address specified in the packet.

In an aspect, the first network device can create multiple IPsec interfaces, each associated with a corresponding second network device such that a packet received at the first network device is mapped to a defined IPsec interface selected from the multiple IPsec interfaces based on a destination IP address of the received packet.

In an aspect, the first network device maintains a tunnel table containing information regarding each IPsec interface of multiple IPsec interfaces to enable received IPsec packets to be transmitted through a defined tunnel of the defined IPsec interface based on destination IP address mapping present in the tunnel table of the defined IPsec interface.

In different implementations, the first network device or the second network device can be any or a combination of a router, a switch, a gateway device, a network controller, a firewall, and a bridge.

The network devices and methods described herein facilitate efficient communication between client devices associated with the first network device and the second network device, wherein a single IPsec interface is created between the first network device and the second network device, and separate tunnels are created for each client device, for sending packets to the first network device, wherein the created tunnels are bound to the single IPsec interface. Embodiments of the present invention may relate to improvements to IPsec VPNs further background for which is provided in the FortiOS™ Handbook—IPsec VPN for FOrtiOS 5.0 (currently available in PDF form at http://docs.fortinet.com/uploaded/files/1086/fortigate-ipsec-vpn-50.pdf) and the FortiOS™ Handbook—IPsec VPN version 5.2.2 (currently available in PDF from at http://docs.fortinet.com/uploaded/files/1881/fortigate-ipsec-vpn-52.pdf), both of which are incorporated herein by reference in their entirety for all purposes.

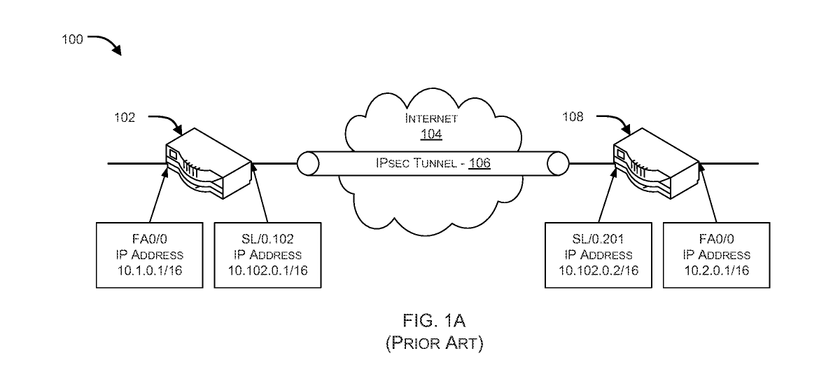

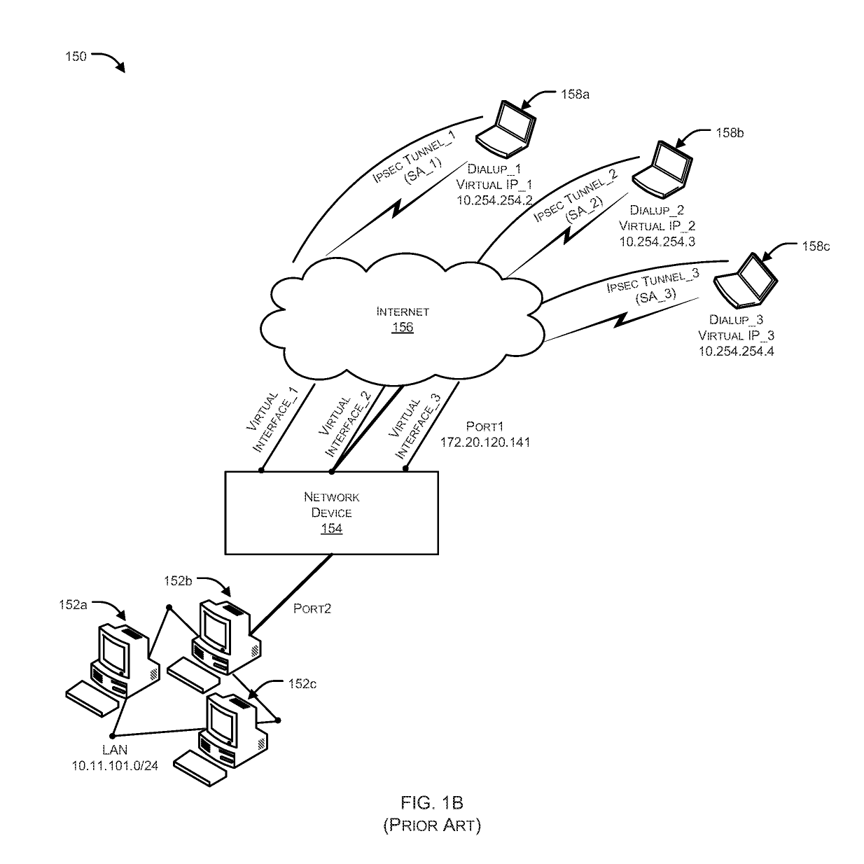

FIGS. 1A and 1B illustrate exemplary network architectures known in the art for providing IPsec tunnel(s) between network devices. In prior art architectures, such as that illustrated in FIG. 1A, every time a request for an IPsec secure connection is received from a client device at a first network device 102 for enabling secure communications between the client device and a second network device 108 or any other network device(s) or client device(s) connected to second network device 108, first network device 102 establishes an independent IPsec interface (not shown) and an IPsec tunnel 106 between first network device 102 and second network device 108. In existing implementations, first network device 102 receives a connection request over an internal interface having a dynamically varying IP address selected from an address pool, and establishes an IPsec interface over an external interface with second network device 108 using another dynamically allocated IP address from another address pool. For each connection request, an IPsec interface is therefore established, and a dynamically allocated IP address is assigned for that interface. When the client device terminates the connection, both the IPsec interface as well as the IPsec tunnel are destroyed, which requires significant computing resources.

FIG. 1B illustrates another exemplary network architecture known in the art for providing IPsec tunnel(s) between network devices. In existing implementations, when any client device 152a-c makes a request to network device 154 for enabling a secure connection between client device 152a-c and a remote device 158a-c, network device 154 creates a virtual IPsec interface and a corresponding IPsec tunnel between network device 154 and the desired destination/remote device 158a-c. As shown in FIG. 1B, for enabling secure connection with remote device 158a, network device 154 creates a virtual interface 1 and IPsec tunnel_1. Similarly, independent and separate IPsec interfaces and tunnels are created between network device 154 and remaining remote/destination devices, e.g., 158b and 158c. Therefore, for each dial-up request from a client device, network device 154 creates an IPsec interface and a corresponding IPsec tunnel.

As noted above, creating a new IPsec interface and tunnel and tearing down of the IPsec interface and tunnel each time a secure connection is opened and closed, respectively, through a network device is computationally expensive, requires updating of routing tables and impacts the performance of other daemons running on the network device.

In contrast, in accordance with embodiments of the present invention a network device provides efficient communication between multiple client devices through a first network device and a second network device, while making use of a single IPsec interface (created in advance or responsive to the first request for a secure connection) to which multiple separate tunnels for each client device are subsequently bound, thereby avoiding the inefficiencies associated with creation and termination of separate and independent IPsec interfaces for each requested secure session.

In an exemplary implementation, when dialup IPsec is configured, a network device can create a single IPsec interface having a static IP address in advance (prior to receiving a request to establish a secure connection) or responsive to a first such request, and configure a static route on the single IPsec interface so that all IP addresses potentially assigned to IPsec dialup users are routed via this single shared IPsec interface. When a new IPsec dialup client dials in, a new tunnel with the assigned IP address can be inserted into the IPsec interface's tunnel list, and when an IPsec dialup client leaves, the tunnel created for that client can be removed from the IPsec interface's tunnel list. Those skilled in the art will appreciate, the proposed tunnel creation and removal described herein forego the constant interface churn (e.g. IPsec interface creation and destruction performed by prior art network devices), thereby avoiding routing table updates, flushing of the data path and other inefficiencies observed in connection with network devices servicing multiple client devices.

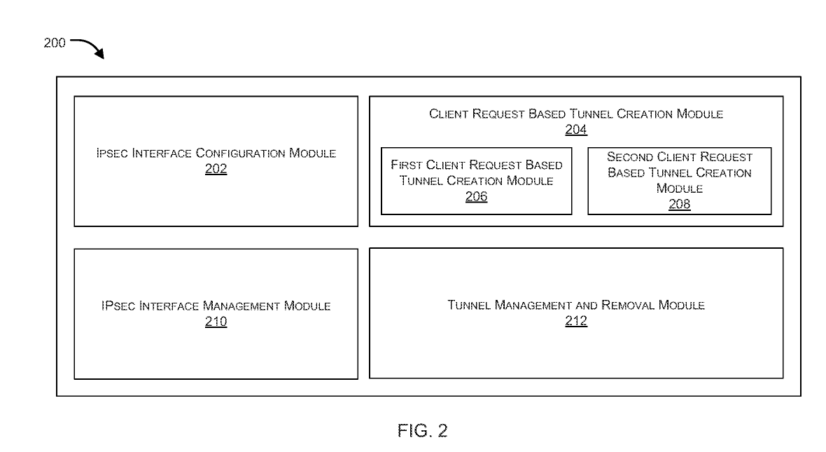

FIG. 2 illustrates an exemplary block diagram of a network device 200 including various functional modules for IPsec interface configuration and management in accordance with an embodiment of the present invention. In an aspect, network device 200 facilitates IPsec interface configuration and management by bundling multiple IPsec dialup tunnels into a single IPsec interface. Network device 200 can include a non-transitory storage device having embodied therein one or more routines operable to manage a single IPsec interface (created in advance or created responsive to receipt of an initial request to create a secure connection) to support multiple client device with multiple IPsec tunnels bound to the single IPsec interface. Network device 200 can also include one or more processors coupled to the non-transitory storage device and operable to execute the one or more routines. The one or more routines can include an IPsec interface configuration module 202 that creates a single IPsec interface between a network device (also interchangeably referred to as first network device) and a second network device, and associate the single IPsec interface with a static IP address. Network device 200 can further include a client request based tunnel creation module 204 to create multiple tunnels, each tunnel being created/instantiated upon receipt of a request to establish a secure connection by a client device and are bound to the single IPsec interface. In an exemplary implementation, client request based tunnel creation module 204 can include a first client request based tunnel creation module 206 to create a first tunnel responsive to a request received from a first client device and associate the first tunnel with the single IPsec interface, and a second client request based tunnel creation module 208 to create a second tunnel responsive to a request received from a second client device and associate the second tunnel with the single IPsec interface. The client request based tunnel creation module 204 can incorporate multiple tunnel creation modules similar to the first/second tunnel creation modules 206/208 so as to be able to create N tunnels and associate the N tunnels with a single IPsec interface created by IPsec interface configuration module 202.

In an exemplary implementation, module 202 can create a new IPsec interface when N IPsec tunnels are already associated with an existing IPsec interface, or when a predefined time-interval of creation of IPsec interface expires. In an exemplary implementation, IPsec interface configuration module 202 can negotiate Security Associations (SAs) assigned to a static IP address, and associate a static route that can be used for creating multiple tunnels for the IPsec interface. IPsec interface configuration module 202 can create the IPsec interface based on negotiation of security and encryption parameters between the first network device and the second network device, wherein all IPsec tunnels associated with the IPsec interface can be bound with the negotiated security and encryption parameters.

In an aspect, multiple IPsec interfaces having respective static IP addresses can be created between different network devices, wherein one or more tunnels can be associated with each IPsec interface to enable client devices to use a defined interface and tunnel depending on the destination client device. For instance, IPsec interface 1 can be created between network devices 1 and 2, and IPsec interface 2 can be created between network devices 1 and 3 such that a client device associated with network device 1 can create and use a tunnel associated with IPsec interface 1 when it wishes to send a packet to a client/remote/destination device associated with network device 2, and can create and use a tunnel associated with IPsec interface 2 when it wishes to send a packet to a client/remote/destination device associated with network device 3.

In an embodiment, a first packet received at the first network device from the first client device can be mapped to the first tunnel based on a destination IP address specified by the first packet. Similarly, a second packet received at the network device from the second client device can be mapped to the second tunnel based on a destination IP address specified by the second packet.

In an exemplary implementation, module 204 can bind the negotiated SAs, assigned IP addresses, and optionally the network behind the client device with the created tunnel, and add the created tunnel to a tunnel list of the single shared IPsec interface.

In an exemplary implementation, network device 200 can include an IPsec interface management module 210 configured to maintain a mapping table of IPsec interface(s) and IPsec tunnels associated with each IPsec interface, wherein tunnels that are associated with each IPsec interface are also referred to as being within the interfaces' tunnel list. Module 210 can therefore, maintain a tunnel list having IPsec tunnels that have been created and associated with a given IPsec interface. When the connection is terminated either by a client device or the destination/remote/second client/communication device, the tunnel is closed and removed from the interface's tunnel list. As such, a single shared IPsec interface is capable of supporting multiple concurrent secure connections between supported client devices and remote devices without creation and tearing down of IPsec interfaces and the associated inefficiencies.

In an aspect, network device 200 can further include a tunnel management and removal module 212 that, upon termination of a connection between a client device associated with a first network device and second network device or remote/destination client device, can result in removal of the IPsec tunnel that was created by the first network device for the client to communicate with the second network device or the remote/destination client device while maintaining the single IPsec interface as active. For example, when connection between the first client and the second network device is terminated, the first tunnel created by the first client request based tunnel creation module 206 can be terminated without discarding/tearing down of the single IPsec interface. Similarly, termination of connection between a second client device and the second network device (or any client device associated with the second network device) can result in removal of the second tunnel, while maintaining the single IPsec interface (configured between the first network device and the second network device) as active.

In an exemplary implementation, when an IPsec packet is received from a client device, first network device that is coupled with the client device can determine the negotiated SA (negotiated at the time of IPsec interface creation between the first network device and second network device), and tunnel the received IPsec packet using the Security Parameter Index (SPI) that is associated with the IPsec interface, enabling efficient identification of the bound interface for a received packet. The received packet, when received at the second network device can be decrypted by using the negotiated SA and forwarded to, for example, the destination/remote client device that is associated with the second network device for further handling.

In an exemplary implementation, when a packet originated by a client device is to be sent via a secure connection to a destination, the IPsec interface can identified through a routing lookup, and, based on the tunnel list of the identified IPsec interface, the SA/tunnel created for the client device's communication can be selected based on the destination address of the packet. For example, a first packet received from a first client device can be mapped to a first tunnel of an IPsec interface based on a destination IP address specified by the first packet, and a second packet received from the second client device can be mapped to a second tunnel associated with the IPsec interface based on a destination IP address specified by the second packet. Although, embodiments of the present disclosure have been described with reference to a single IPsec interface, those of ordinary skill in the art will appreciate that any number of IPsec interfaces can be created between network devices.

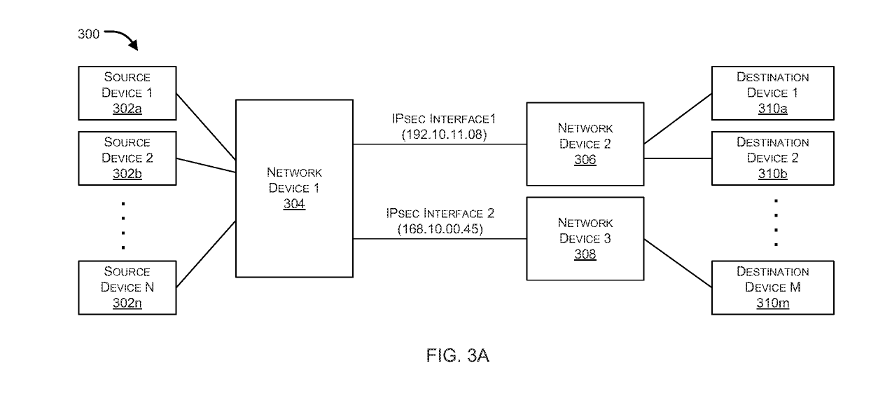

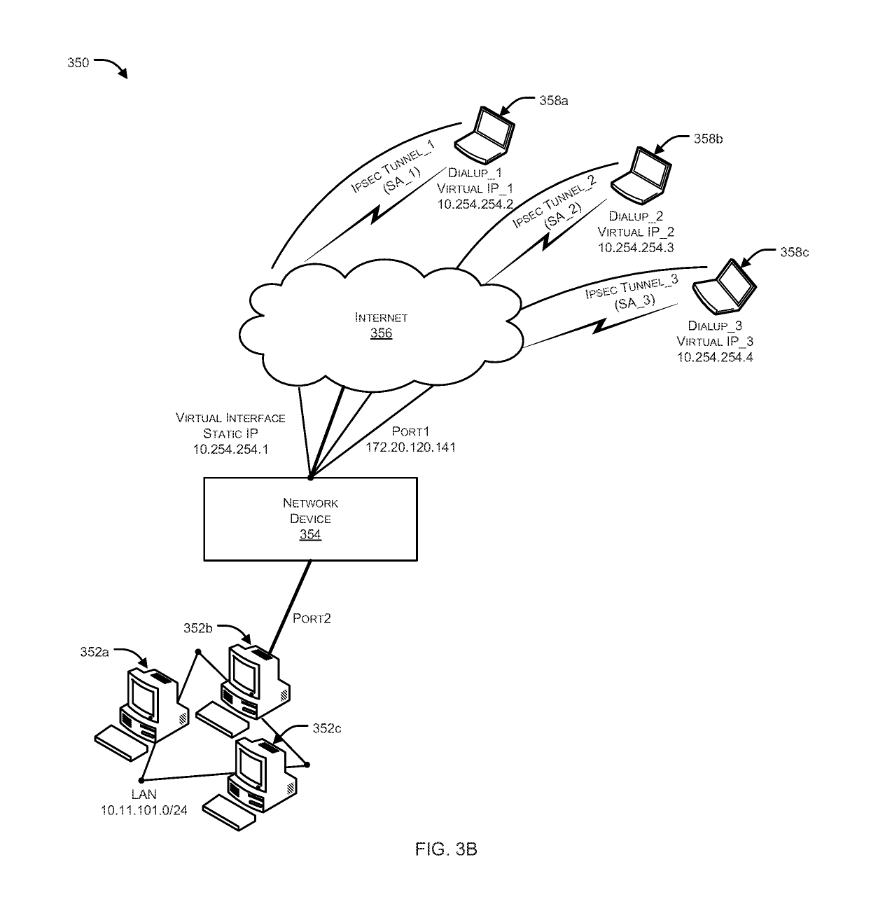

FIGS. 3A and 3B illustrate exemplary network architectures 300 and 350 using a single IPsec interface based configuration in accordance with embodiments of the present disclosure. As shown in FIG. 3A, a network device 1 304 (e.g., a virtual private network (VPN) gateway) can create an IPsec interface 1 and associate therewith a static IP address (e.g., 192.10.11.08) to enable a secure IP connection between network device 1 304 (on behalf of any source device 302a-n) and network device 2 306 (e.g., a remote VPN gateway to which network device 1 304 is connected though a public network, such as the Internet) (and its associated destination devices 310a and 310b, for instance).

IPsec interface 1 can be created between the network device 1 304 and network device 2 306 when an initial request from any of the source device 302a-n is made for a secure connection with any of the associated destination devices (e.g., destination device 1 310a or destination device 2 310b). Alternatively, IPsec interface 1 may be created by network device 1 304 in advance (e.g., at startup) (prior to such an initial request) so as to be available for use without delay upon receipt of such an initial request.

After creation of the IPsec interface 1, when network device 1 304 receives a request to set up a secure connection or a packet transmission request from any source device 302a-n that is to be routed through network device 2 306 to a desired destination device, for example destination device 1 310a, network device 1 304 can create a new tunnel within the same IPsec Interface 1. IPsec interface 1 can be maintained even after the connection terminates between source device 302a and destination device 310a.

Similarly, for another pair of communicating devices whose traffic needs to be routed through network device 3 308, an IPsec interface 2 with a static IP address (e.g., 168.10.00.45) can be created between the network device 1 304 and network device 3 308 (e.g., another remote VPN gateway). Once the IPsec interface 2 is created, network device 1 304, upon receiving a connection request from any source device 302a-n and/or a packet directed to destination device 310m, can create an IPsec tunnel for the requested connection and bind it to the IPsec interface 2.

In an exemplary implementation, responsive to receiving a packet, when no tunnel currently exists, network device 1 304 can determine, based on the destination IP address specified in the packet, which network device (for example, which of network devices 2 or 3) and hence which IPsec interface through which the packet is to be transmitted, thereby allowing network device 1 304 to create and associate a tunnel therewith, and subsequently use the tunnel to transmit this and subsequent packets to the specified destination IP address. For all subsequent packets, from any source device 302a-n, if the packet is destined for the same destination device/IP address for which IPsec interface is created, network device 1 304 can create additional IP tunnels and bind the created IPsec tunnels with the IPsec interface. As such, in accordance with embodiments of the present invention in the context of FIG. 3A, despite the N×M potential pairs of source devices 302a-n and destination devices 310a-m that might require a secure connection, only two IPsec interfaces will exist and any given time (without being continually established and torn down) and with which appropriate individual tunnels may be associated.

FIG. 3B illustrates another exemplary network architecture 350 using a single IPsec virtual interface based configuration in accordance with embodiments of the present disclosure. As shown in FIG. 3B, a network device 354 (e.g., a VPN gateway) can create a single virtual interface with a static IP address to enable LAN devices 352a-c to communicate with destination devices 358a-c through the Internet 356. N view of the prior example discussed with reference to FIG. 3A, as one of ordinary skill in the art will appreciate, for the LAN devices 352a-c, a single IPsec interface can be created having a static IP address (e.g., 10.254.254.1) to support multiple tunnels for various pairs of communicating devices. For example, a secure connection can be created between a source device 358a-358c and a destination device 352a-c that is routed through network device 354 and a next hop network device (not shown), by creating a new IPsec tunnel, which can be bound to the virtual IPsec interface.

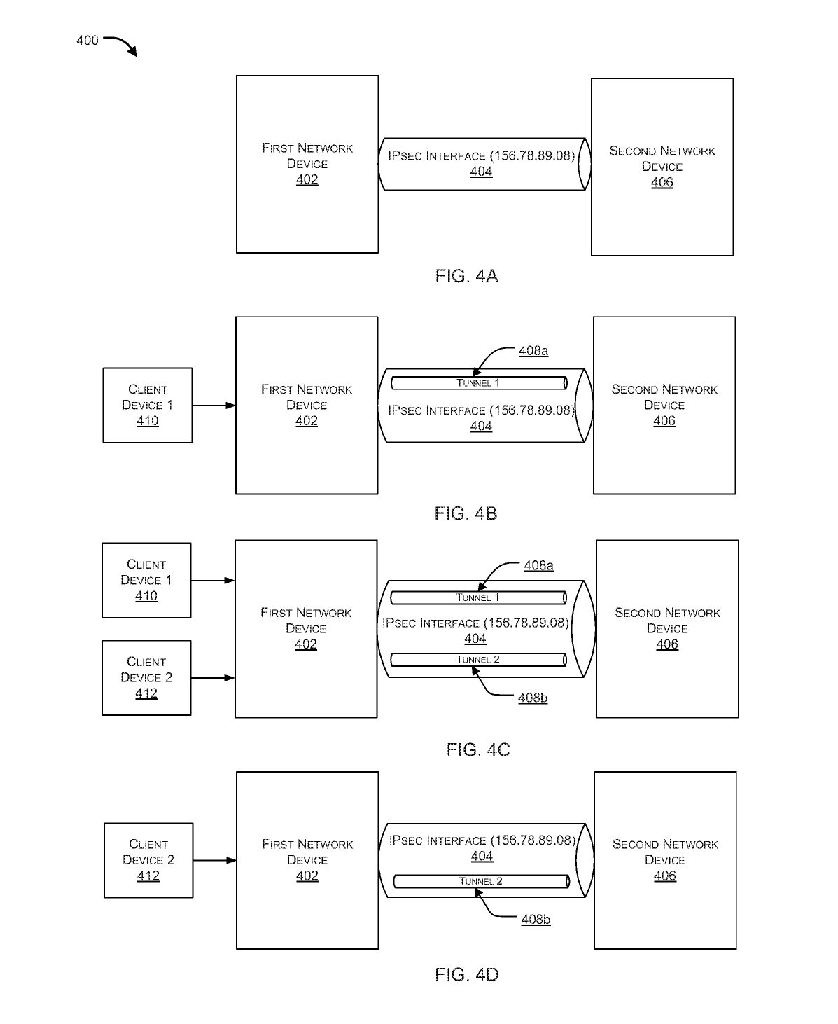

FIGS. 4A to 4D illustrate exemplary sequential representations showing tunnel creation and management over a single IPsec interface in accordance with an embodiment of the present disclosure. As shown in FIG. 4A, an IPsec interface 404 having a static IP address (e.g., 156.78.89.08) can be created between a first network device 402 and a second communication/network device 406. In an exemplary implementation, IPsec interface 404 can be pre-created or established by the first network device 402 and/or by the second network device 406. Alternatively, IPsec interface 404 can be created when the need arises (e.g., when a first IPsec connection request is received by the first network device 402 relating to a destination device coupled to second network device 406).

As shown in FIG. 4B, once IPsec interface 404 has been created, first network device 402, upon receiving a request from a client device 410, can create a first IPsec tunnel (e.g., tunnel 1 408a) and bind the IPsec tunnel 1 408a with pre-created IPsec interface 404. Similarly, as shown in FIG. 4C, when a request is received from client device 2 412, first network device 402 can create another IPsec tunnel 408b and bind tunnel 2 408b with the same IPsec interface 404. When a connection is terminated by any of the client devices, only the IPsec tunnel (e.g., IPsec tunnel 408a or 408b) associated the terminated connection is closed, and the single shared IPsec interface 404 remains unchanged (other than removal of the tunnel associated with the terminated connection from its tunnel list).

The persistence of IPsec interface 404 is illustrated by FIG. 4D. When client device 1 410 terminates its secure connection between first network device 402 and second network device 406, first network device 402 removes IPsec tunnel 408a from the tunnel list of IPsec interface 404, but maintains IPsec interface 404 along with other tunnels that may be associated with it. As can be seen in FIG. 4D, IPsec tunnel 1 408a has been removed, and IPsec tunnel 2 408b and IPsec interface 404 remain.

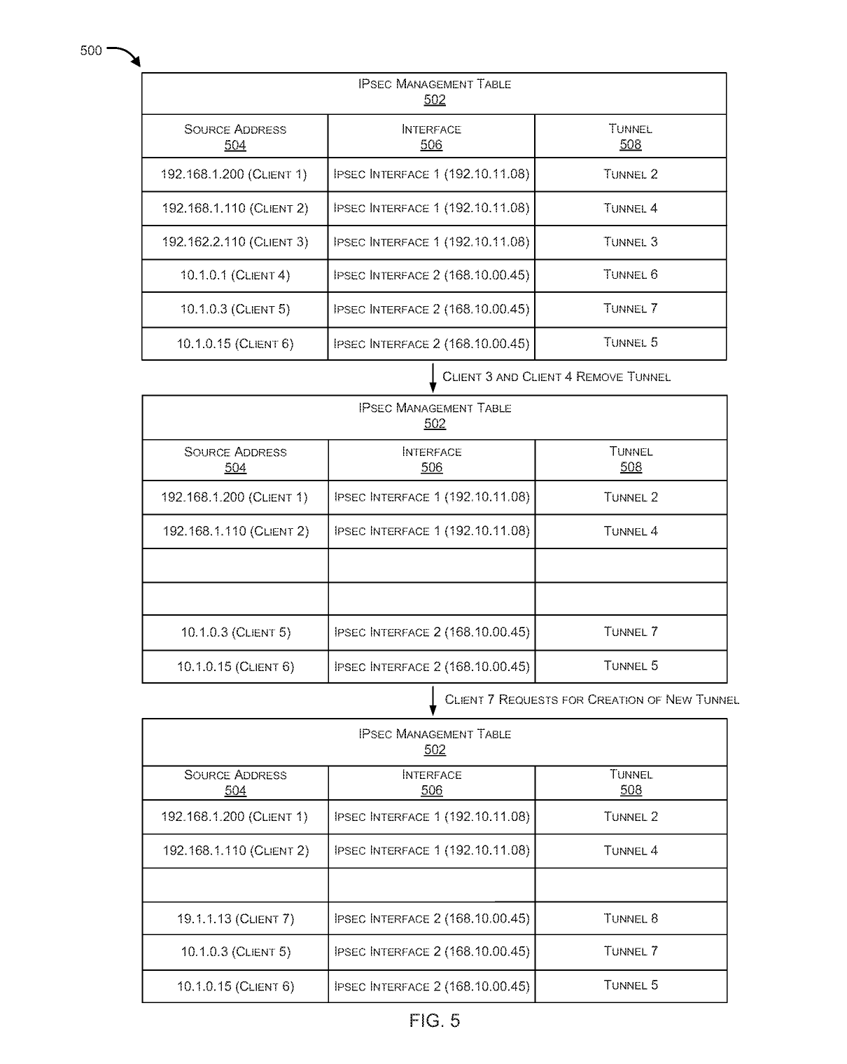

FIG. 5 illustrates exemplary representations showing tunnel creation and management over multiple IPsec interfaces in accordance with an embodiment of the present disclosure. As shown in FIG. 5, network devices can be configured to store an IPsec management table (which may be interchangeably referred to herein as a system level or a logical table/representation), e.g., table 502 that can store a mapping between source address 504, IPsec interface 506, and IPsec tunnel 508. In an exemplary aspect, IPsec management table 502 can be updated when a new IPsec interface is created, or when a new IPsec tunnel is created/discarded, or based on any other change of interaction between the client devices and the corresponding interfaces/tunnels. For example, IPsec management table 502, at a particular instance, may have two IPsec interfaces, IPsec interface 1 with static IP 192.10.11.08, and IPsec interface 2 with static IP 168.10.00.45. These two IPsec interfaces can each be associated with and used by multiple tunnels. For example, tunnel 2, tunnel 4, tunnel 3 can be created and bound, upon request of client 1, client 2, and client 3 respectively, to IPsec interface 1. Similarly, tunnel 6, tunnel 7, and tunnel 5 can be created and bound to IPsec interface 2 upon request of client 4, client 5 and client 6 respectively. In this situation, when clients 3 and 4 terminate respective connections, corresponding tunnels 3 and 7 get removed from the table 502. However, even as tunnels 3 and 7 are removed, IPsec interface 1 and IPsec interface 2 on which they were respectively created are still maintained. Further, when a new client 7 requests creation of new IPsec connection, the network device can, based on the source IP address and/or destination IP address, determine if any IPsec interface exists to serve the connection request. When an IPsec interface already exists that may service the new connection request, network device can simply create a new tunnel, for example tunnel 8, and bind the tunnel 8 to the existing IPsec interface (e.g., IPsec interface 2). In an exemplary implementation, when subsequent packets are received from the same client and for the same destination, the network device can refer to the IPsec interface table 502 for making a decision on whether to transfer the newly received packets over an existing tunnel, or to create a new tunnel for an existing over IPsec interface. In an exemplary implementation, an existing IPsec interface can, depending on availability of resources and other such criteria, be discarded when the interface is not used for a predefined period of time.

When a packet with plain information is needed to be sent by a client device, an appropriate IPsec interface can be chosen through routing lookup, and from the chosen IPsec interfaces' tunnel list, SA/tunnel created for the client device communication can be selected based on the destination address of a packet. Packets can be encrypted using negotiated SA, and sent out over the IPsec tunnel. When IPsec dialup user dials in, a pair of SAs can be negotiated for encryption as well as for decryption before setting up IPsec interface. In an exemplary implementation, the network device can allocate an IPsec tunnel object for a client device, link the decryption SA into tunnel's decryption SA list (isa_head), link the encryption SA into tunnel's encryption SA list (osa_head), put the tunnel into its interface's tunnel HASH table hashed by peer address, and put the tunnel into the system-level tunnel HASH table hashed by SPI of decryption SA.

In an exemplary implementation, in order to quickly locate a decryption SA, the network device, while receiving an encrypted packet, may use a system level HASH table (IPsec management table) or refer to a binary search tree that may contain all IPsec tunnels indexed by SPI, or SPI+tunnel's remote gateway address.

In an embodiment, the disclosure provides a method for bundling multiple IPsec dialup tunnels into a single IPsec interface and processing the received packets, wherein the disclosed method can be implemented by one or more processors at a network device.

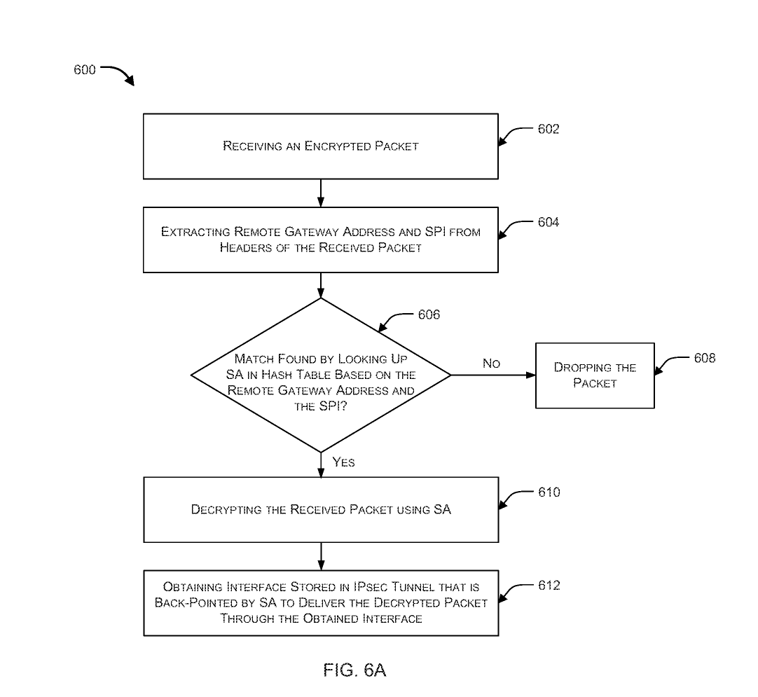

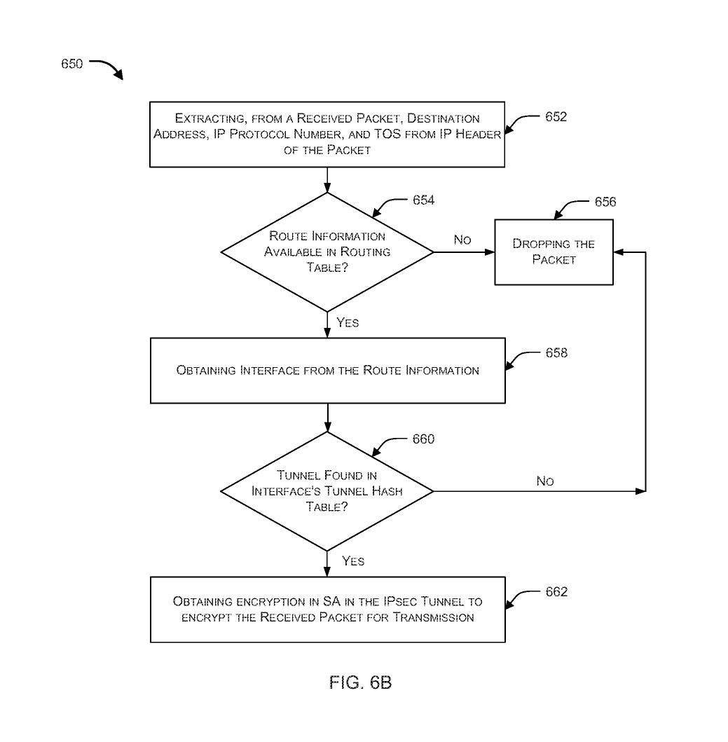

FIG. 6A illustrates an exemplary flow diagram 600 indicating steps taken by the network device for processing a packet originated remotely (an encrypted packet) and received on a single shared IPsec interface in accordance with an embodiment of the present disclosure. Responsive to receipt of an IPsec packet at the network device, the network device determines the corresponding SA and tunnel based on its SPI in the system level HASH table, and thereby also identifies the bound interface. The received packet can be decrypted using the determined SA and sent for further handling. As shown in FIG. 6A, processing of a remotely originated packet can include the steps of receiving an encrypted packet as shown at step 602; extracting the remote gateway address and SPI from headers of the received packet at step 604; and at step 606, based on the extracted remote gateway address and the SPI, determining if a match is found by looking up the SA in the hash table. When no SA is found, the encrypted packet can be dropped as shown at step 608; otherwise, when the SA is found, the method can, at step 610, decrypt the received packet using the SA and obtain information regarding the interface stored in IPsec tunnel that is back-pointed by SA to deliver the decrypted packet through the obtained interface as show at step 612. As explained earlier, the SA can be as negotiated at the time of IPsec interface creation.

FIG. 6B illustrates an exemplary flow diagram 650 indicating steps taken by a network device for processing a packet originated locally (an unencrypted packet) to be transmitted via a single shared IPsec interface in accordance with an embodiment of the present disclosure. In accordance with the present example, responsive to receipt of an IPsec packet via a particular tunnel of a single shared IPsec interface the network device extracts the destination address, the IP protocol number, and TOS from the IP header of the packet as shown at step 652. The network device then ascertains at step 654, if route information for the packet is available in the routing table. When route information for the packet is available, at step 658, information identifying the shared single IPsec interface can be obtained from the route information. At step 660, the corresponding tunnel is attempted to be located in the tunnel has table of shared single IPsec interface. When the tunnel is found, processing continues with step 662 in which the appropriate encryption parameters are obtained from the SA of identified tunnel to encrypt the received packet for transmission via the identified tunnel as shown at step 662. When the tunnel is not found, processing branches to step 656 wherein the received packet is dropped. The method described herein assumes that the single shared IPsec interface has already been created and the appropriate tunnel has also already been created.

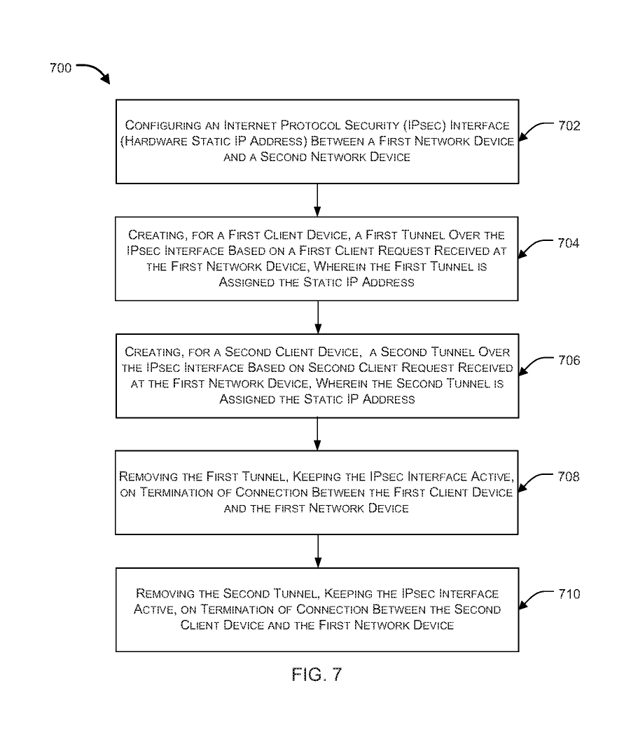

FIG. 7 is an exemplary flow diagram 700 showing steps of IPsec interface creation, along with creation/management of tunnels corresponding to the created IPsec interface in accordance with an embodiment of the present disclosure.

In accordance with an embodiment of the present invention, a method for bundling of multiple tunnels over a single IPsec interface can include the steps of configuring an IPsec interface with a static IP address between a first network device and a second network device as shown at step 702; creating for a first client device, a first tunnel through the IPsec interface based on a first client request received at the first network device, wherein the first tunnel is assigned the static IP address as shown at step 704; creating for a second client device, a second tunnel through the IPsec interface based on second client request received at the first network device wherein the second tunnel is assigned the static IP address as show at step 706. The method further includes the step of removing the first tunnel, and keeping the IPsec interface active, upon termination of the connection between the first client device and the first network device as shown at step 708, and removing the second tunnel, and keeping the IPsec interface active, upon termination of the connection between the second client device and the first network device as shown at step 710.

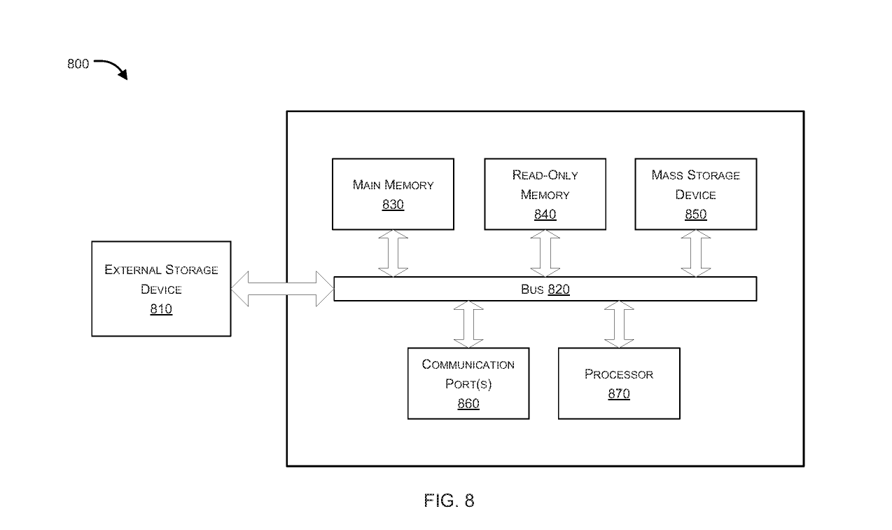

FIG. 8 illustrates an exemplary computer system 800 in which or with which embodiments of the present invention may be utilized. Computer system 800 may represent a network device that performs VPN gateway functionality (e.g., a Uniform Threat Management device (e.g., a FortiGate network security appliance available from the assignee of the present invention) or other otherwise facilitates secure communications between client devices. Computer system 800 a may perform bundling of multiple tunnels over a single IPsec interface as described above. Embodiments of the present disclosure include various steps, which have been described above. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware.

As shown, computer system 800 can include a bus 820, a processor 870, communication port 860, a mass storage device 850, an external storage device 810, a read only memory 840 and a main memory 830. A person skilled in the art will appreciate that computer system 800 may include more than one processor and communication ports. Examples of processor 870 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 805 may include various modules associated with embodiments of the present invention.

Communication port 860 can be any of an RS-232 port for use with a modem based dialup connection, a 10/100 Ethernet port, a Gigabit or 10 Gigabit port using copper or fiber, a serial port, a parallel port, or other existing or future ports. Communication port 860 may be chosen depending on a network, such a Local Area Network (LAN), Wide Area Network (WAN), or any network to which computer system 800 connects.

Memory 830 can be Random Access Memory (RAM), or any other dynamic storage device commonly known in the art. Read only memory 840 can be any static storage device(s) e.g., but not limited to, a Programmable Read Only Memory (PROM) chips for storing static information e.g. start-up or BIOS instructions for processor 805. Mass storage 850 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 820 communicatively couples processor(s) 870 with the other memory, storage and communication blocks. Bus 820 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 870 to software system. Optionally, operator and administrative interfaces, e.g. a display, keyboard, and a cursor control device, may also be coupled to bus 820 to support direct operator interaction with computer system 800.

Other operator and administrative interfaces can be provided through network connections connected through communication port 860. external storage device 810 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

What is claimed is:

1. A network device comprising:
a non-transitory storage device having embodied therein one or more routines operable to manage a single Internet Protocol security (IPsec) interface to support a plurality of IPsec tunnels for a plurality of client devices; and
one or more processors coupled to the non-transitory storage device and operable to execute the one or more routines, wherein the one or more routines include:
an interface configuration module, which when executed by the one or more processors, creates the single IPsec interface between the network device and a second network device and associates the single IPsec interface with a static Internet Protocol (IP) address;
a first client request based tunnel creation module, which when executed by the one or more processors, creates a first tunnel responsive to a request received from a first client device, and associates the first tunnel with the single IPsec interface; and
a second client request based tunnel creation module, which when executed by the one or more processors, creates a second tunnel responsive to a request received from a second client device, and associates the second tunnel with the single IPsec interface.

2. The network device of claim 1, wherein the IPsec interface is configured with a static route.

3. The network device of claim 1, wherein the interface configuration module is further configured to create the IPsec interface based on negotiation of security and encryption parameters between the network device and the second network device.

4. The network device of claim 3, wherein the first client request based tunnel creation module is further configured to bind the first tunnel with the negotiated security and encryption parameters.

5. The network device of claim 1, wherein a first packet received from the first client device is mapped to the first tunnel based on a destination IP address specified by the first packet.

6. The network device of claim 1, wherein a second packet received from the second client device is mapped to the second tunnel based on a destination IP address specified by the second packet.

7. The network device of claim 1, wherein termination of a connection between the first client device and the network device results in removal of the first tunnel, but the single IPsec interface remains active.

8. The network device of claim 1, wherein termination of a connection between the second client device and the network device results in removal of the second tunnel, but the single IPsec interface remains active.

9. A method comprising:
configuring, by a first network device, an Internet Protocol security (IPsec) interface between the first network device and a second network device, wherein the IPsec interface is associated with a static Internet Protocol (IP) address;
creating, for a first client device, a first tunnel associated with the IPsec interface based on a first client request received at the first network device, wherein the first tunnel is assigned the static IP address; and
creating, for a second client device, a second tunnel associated with the IPsec interface based on second client request received at the first network device, wherein the second tunnel is assigned the static IP address.

10. The method claim 9, wherein the IPsec interface is configured with a static route.

11. The method claim 9, wherein the IPsec interface is configured based on negotiation of security and encryption parameters between the first network device and the second network device.

12. The method claim 11, the first tunnel is bound with the negotiated security and encryption parameters.

13. The method claim 9, further comprising:
receiving, by the first network device, a first packet from the first client; and
identifying, by the first network device, a corresponding security association and the first tunnel based on a destination Internet Protocol (IP) address specified by the first packet.

14. The method claim 9, further comprising:
receiving, by the first network device, a second packet from the second client; and
identifying, by the first network device, a corresponding security association and the second tunnel based on a destination Internet Protocol (IP) address specified by the second packet.

15. The method claim 9, further comprising:
receiving, by the first network device, a first IPsec packet from the second network device; and
identifying, by the first network device, a corresponding security association to be used to decrypt the first IPsec packet based on a Security Parameter Index (SPI) specified by the first IPsec packet.

16. The method claim 9, wherein termination of a connection between the first client device and the first network device results in removal of the first tunnel, but the IPsec interface remains active.

17. The method claim 9, wherein termination of a connection between the second client device and the first network device results in removal of the second tunnel, but the IPsec interface remains active.

18. The method claim 9, wherein the first network device creates a plurality of IPsec interfaces, each of the plurality of IPsec interfaces being associated with a corresponding second network device such that a packet received at the first network device is mapped to a defined IPsec interface selected from the plurality of IPsec interfaces based on a destination IP address of the received packet.

19. The method claim 9, further comprising maintaining, by the first network device a tunnel table containing information regarding each IPsec interface of the plurality of IPsec interfaces, and wherein received IPsec packets are transmitted through a defined tunnel of the defined IPsec interface based on the destination IP address mapping present in the tunnel table of the defined IPsec interface.

20. The method claim 9, wherein the first network device or second network device is selected from a group comprising of a router, a switch, a gateway device, a network controller, a firewall, and a bridge.
